(19) United States
(12) Patent Application Publication
(10) Pub. No.: US 2012/0199168 A1
(43) Pub. Date: Aug. 9, 2012

(54) APPARATUS FOR CLEANING A PAINTING TOOL

(75) Inventor: Tristan Campbell, New South Wales (AU)

(73) Assignees: Marjorie Rose Campbell, New South Wales (AU); Serj Super Pty Ltd, New South Wales (AU); Laurence Raymond Godden, New South Wales (AU)

(21) Appl. No.: 13/366,761

(22) Filed: Feb. 6, 2012

(30) Foreign Application Priority Data
Feb. 8, 2011 (AU) AU2011900403

(51) Int. Cl. A46B 17/06; B08B 3/02

(52) U.S. Cl. 134/182; 134/200

(57) ABSTRACT

The present invention relates to an apparatus for cleaning a painting tool. The apparatus comprises an inlet for inflow of cleaning fluid, a first compartment in fluid communication with the inlet for buffering the cleaning fluid, a second compartment for insertion of a painting tool, where the second compartment is separated from the first compartment by a partition wall including one or more openings for the cleaning fluid buffered in the first compartment to pass through to the second compartment, and a dispersing element for dispersing at least a portion of the cleaning fluid passing through the one or more openings onto the painting tool.

### FIELD OF THE INVENTION

The present invention relates broadly to an apparatus for cleaning a painting tool, and particularly to an apparatus for cleaning a painting tool using external cleaning fluid such as tap water.

### BACKGROUND OF THE INVENTION

One way to clean a painting tool, such as a paintbrush, and remove residual paint from the tool is to hold the tool under a running tap. However the pressure from the tap may not be sufficiently high for water to penetrate into inner layers of the tool's bristles to thoroughly clean the tool. Furthermore running the tap at high pressure may splatter water and the residual paint on to surrounding areas.

### SUMMARY OF THE INVENTION

According to the present invention there is provided an apparatus for cleaning a painting tool, the apparatus comprising:

an inlet for inflow of cleaning fluid;

a first compartment in fluid communication with the inlet for buffering the cleaning fluid;

a second compartment for insertion of a painting tool, the second compartment being separated from the first compartment by a partition wall including one or more openings for the cleaning fluid buffered in the first compartment to pass through to the second compartment; and

a dispersing element for dispersing at least a portion of the cleaning fluid passing through the one or more openings onto the painting tool.

Preferably the dispersing element includes a deflecting element for deflecting the cleaning fluid onto the painting tool. More preferably the deflecting element includes a downwardly angled flange for downwardly deflecting the cleaning fluid onto the painting tool. Even more preferably the flange includes a flat portion for dispersing the cleaning fluid into one or more continuous bands of cleaning fluid.

Preferably the total cross sectional area of the one of more openings is less than the cross sectional area of the inlet.

Preferably the one of more openings include one or more circular openings. More preferably each of the one or more circular openings is no more than approximately 1 millimetre in diameter.

Preferably the cleaning fluid includes water.

Preferably the apparatus further comprises an outlet for outflow of the cleaning fluid.

More preferably the outlet is in fluid communication with the second compartment.

Preferably the apparatus further comprises a supporting component for supporting the apparatus on a rim of a bucket.

Preferably the second compartment is surrounded by the first compartment.

Preferably the second compartment is defined by the partition wall.

Preferably the first compartment is defined by a casing and the partition wall.

Preferably the apparatus is made of material selected from plastic, steel and aluminium.

### BRIEF DESCRIPTION OF THE ACCOMPANYING DRAWINGS

FIG. 1 A perspective view of an embodiment of the cleaning apparatus according to the present invention.

FIG. 2 A cut-away view of the embodiment of the cleaning apparatus illustrated in FIG. 1.

### DETAILED DESCRIPTION OF THE PREFERRED EMBODIMENT(S)

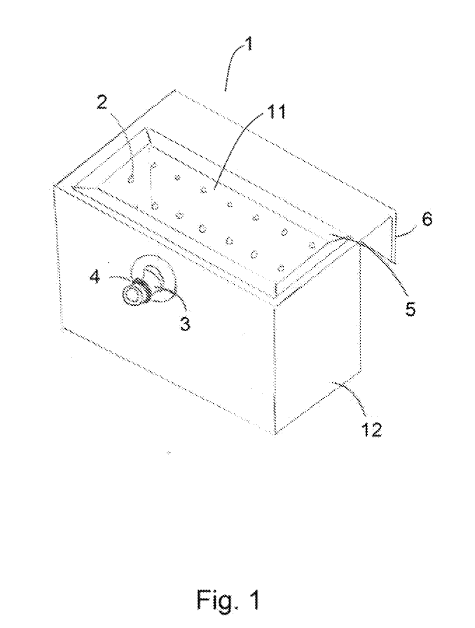

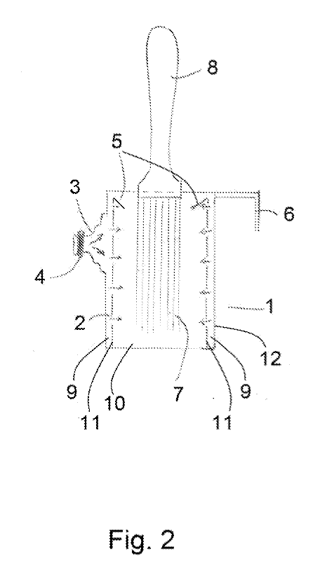

FIGS. 1 and 2 illustrate different views of an embodiment of an apparatus for cleaning a painting tool, such as a paintbrush 8, according to the present invention. The cleaning apparatus 1 generally comprises (a) an inlet 3 for inflow of cleaning fluid, such as water, (b) a first compartment 9 in fluid communication with the inlet 3 for buffering the cleaning fluid and (c) a second compartment 10 for insertion of the painting tool 8 therein. The inlet 3 may include a male adaptor with a rubber seal 4 and is suitable for use with a common garden hose. As illustrated in FIG. 2, the first compartment 9 is an outer compartment surrounding the second compartment 10, which is an inner compartment. The inner compartment 10 is shaped to accommodate a relatively large paintbrush such as 8 whilst allowing movement of the paintbrush 8 back and forth within the inner compartment 10. The inner compartment 10 is defined by a partition wall 11, which also separates the inner compartment 10 from the outer compartment 9. The outer compartment 9 is in turn defined by the partition wall 11 and a casing 12. The apparatus 1 may be made of plastic, steel and/or aluminium.

In this embodiment, the partition wall 11 includes one or more generally circular openings 2 for the cleaning fluid initially buffered in the outer compartment 9 to pass therethrough to the inner compartment 10. The openings 2 may be arranged in rows and/or columns and may be evenly distributed in the partition wall 11. For example, FIG. 1 illustrates 7 columns of openings 2 in a single side of the partition wall 11 and FIG. 2 illustrates 5 rows of openings 2 in at least two sides of the partition wall 11. The arrows in FIG. 2 illustrate the direction at which the cleaning fluid may be directed when leaving the openings 2. In some embodiments, the apparatus 1 may be designed such that the total cross sectional area of the openings 2 is less than the cross sectional area of the inlet 3, thereby increasing the pressure at which the cleaning fluid leaves the openings 2. The openings 2 therefore allow the buffered cleaning fluid to be jetted, sprayed or otherwise directed towards the paintbrush 8 at a higher pressure than that of the water tap. This higher pressure may assist in the cleaning fluid penetrating inner layers of the bristles of the paintbrush 8. The diameter of the openings 2 are typically no more than 1 millimetre.

The apparatus 1 according to the present invention also comprises a dispersing element for dispersing at least a portion of the cleaning fluid passing through the openings 2 onto the painting tool. The dispersing element may include a deflecting element, such as a downwardly angled flange 5, for deflecting the cleaning fluid from its path indicated by the arrows towards the paintbrush 8. As illustrated in FIG. 2, the flange 5 extends downwardly from the rim of the partition wall 11 and is designed to intercept and deflect the cleaning fluid having passed through the openings near the rim of the top of the partition wall 11. The flange 5 has a flat portion designed to disperse the cleaning fluid into one or more continuous bands of cleaning fluid. This ensures that the paintbrush 8 may be cleaned more uniformly as compared to being cleaned by an apparatus without the flange 5. The flange 5 and deflected band of cleaning fluid also serve to reduce splashing or splattering of cleaning fluid and/or paint outside the cleaning apparatus 1 by largely containing these liquids to the inner compartment 10.

The apparatus 1 may also comprise an outlet (not illustrated), which is in fluid communication with the inner compartment 10, for outflow of the cleaning fluid containing any residual paint resulted from cleaning the paintbrush 8. The apparatus 1 may further comprises a supporting component, such as a bracket 6, for supporting the apparatus 1 on a rim of a bucket, so that the outflow from the outlet may be collected in the bucket before being properly disposed of.

Now that an embodiment of the cleaning apparatus has been described, it should be apparent that the present invention at least in its preferred embodiment has the following advantages:

The openings result in a higher cleaning fluid pressure which assists in cleaning inner layers of the bristles of a paintbrush or other painting tools.

The dispersing element which results in continuous band(s) of cleaning fluid allows more uniform cleaning of the painting tool than separated jets of cleaning fluid from the individual openings.

It will be appreciated by persons skilled in the art that numerous variations and/or modifications may be made to the invention as shown in the specific embodiments without departing from the spirit or scope of the invention as broadly described. For example, there may be more or less than the number of columns and rows of openings illustrated. The casing may not be rectangular as illustrated but may be of another shape. The present embodiments are, therefore, to be considered in all respects as illustrative and not restrictive.

1. An apparatus for cleaning a painting tool, the apparatus comprising:
an inlet for inflow of cleaning fluid;
a first compartment in fluid communication with the inlet for buffering the cleaning fluid;
a second compartment for insertion of a painting tool, the second compartment being separated from the first compartment by a partition wall including one or more openings for the cleaning fluid buffered in the first compartment to pass through to the second compartment; and
a dispersing element for dispersing at least a portion of the cleaning fluid passing through the one or more openings onto the painting tool.

2. The apparatus of claim 1 wherein the dispersing element includes a deflecting element for deflecting the cleaning fluid onto the painting tool.

3. The apparatus of claim 2 wherein the deflecting element includes a downwardly angled flange for downwardly deflecting the cleaning fluid onto the painting tool.

4. The apparatus of claim 3 wherein the flange includes a flat portion for dispersing the cleaning fluid into one or more continuous bands of cleaning fluid.

5. The apparatus of claim 1 wherein the total cross sectional area of the one of more openings is less than the cross sectional area of the inlet.

6. The apparatus of claim 1 wherein the one of more openings include one or more circular openings.

7. The apparatus of claim 6 wherein each of the one or more circular openings is no more than approximately 1 millimeter in diameter.

8. The apparatus of claim 1 wherein the cleaning fluid includes water.

9. The apparatus of claim 1 further comprising an outlet for outflow of the cleaning fluid.

10. The apparatus of claim 9 wherein the outlet is in fluid communication with the second compartment.

11. The apparatus of claim 1 further comprising a supporting component for supporting the apparatus on a rim of a bucket.

12. The apparatus of claim 1 wherein the second compartment is surrounded by the first compartment.

13. The apparatus of claim 1 wherein the second compartment is defined by the partition wall.

14. The apparatus of claim 1 wherein the first compartment is defined by a casing and the partition wall.

15. The apparatus of claim 1 wherein the apparatus is made of material selected from plastic, steel and aluminium.
